(19) United States
(12) Patent Application Publication
(10) Pub. No.: US 2026/0015790 A1
(43) Pub. Date: Jan. 15, 2026

(54) STRUCTURAL COLOR SYSTEM BASED ON SUPERCRITICAL MICROEMULSION PHASE SEPARATION, PREPARATION METHOD THEREFOR AND USE THEREOF

(71) Applicant: SOOCHOW UNIVERSITY, Suzhou (CN)

(72) Inventor: Jiajie LONG, Suzhou (CN)

(21) Appl. No.: 19/333,589

(22) Filed: Sep. 19, 2025

Related U.S. Application Data
(63) Continuation of application No. PCT/CN2023/141262, filed on Dec. 22, 2023.

(30) Foreign Application Priority Data
Sep. 28, 2023 (CN) 202311275935.6

(51) Int. Cl. D06P 1/94; B01D 17/04; B01F 23/41; B01F 23/45; B01F 25/50; D06P 1/00

(52) U.S. Cl. CPC D06P 1/94; B01D 17/042; B01D 17/044; B01F 23/4143; B01F 23/45; B01F 25/50; D06P 1/0004

(57) ABSTRACT

A working solution is prepared using an amphiphilic emulsifier, water, and a cosolvent as raw materials, so that a microemulsion with specific components is first formed in a supercritical fluid. Then, the system conditions are gradually changed to perform phase separation, thereby obtaining the structural color system. Patterns of different shapes can be further obtained by controlling different pressure and temperature conditions. In the present invention, structural colors are generated based on supercritical microemulsion phase separation, realizing non-pigment coloration of a solution system. In addition, patterns of different shapes can be obtained by controlling process conditions, so the present invention has good application markets and prospects in fields such as related display or light-shielding devices and other coloration applications. The structural color system obtained in the present invention has flexible characteristics and can be used in the field of flexible wearables.

### FIELD OF THE INVENTION

The present invention relates to a method for generating structural color based on supercritical microemulsion phase separation, and belongs to the technical field of material processing or textile dyeing and finishing.

### BACKGROUND OF THE INVENTION

At present, there are two main ways for objects to present colors (i.e., object colors). One way is that colorants with conjugated systems or chromophores in their molecular structures selectively absorb incident light and then reflect visible light of the remaining wavelengths to present colors. For example, various dyes and coatings commonly used in the textile industry can be used for printing and dyeing textiles to obtain various colors and patterns. The other way is that the object itself has a special structure on its surface, or forms a special structure after processing. This structure can cause scattering, interference, and/or diffraction of incident light, allowing visible light of specific wavelengths to enter the human visual system, thereby generating colors, which is called structural coloration. Since the coloration process using colorants requires the use and discharge of large quantities of chemicals, which particularly leads to the residue of colorants, it poses severe challenges to ecological environmental protection and environmental governance. In contrast, structural coloration is mainly a physical coloration method, which has excellent green and ecological characteristics. Therefore, in recent years, structural coloration technology has become a research hotspot at home and abroad.

Supercritical fluid, especially supercritical carbon dioxide (SCF-CO₂) fluid, uses critical-state media such as CO₂ instead of water as the processing medium. It can fundamentally change the traditional wet chemical processing method, usually consuming little or no fresh water resources, and no pollutants such as wastewater are generated or discharged. It has significant clean production characteristics including greenness, ecology, energy conservation, and emission reduction. In addition, this type of processing also has advantages including short process flow, convenient operation, low viscosity of the fluid medium, high diffusivity, high processing efficiency, and short process time. Therefore, supercritical fluid technology, especially SCF-CO₂ technology, has been widely promoted and applied in fields such as textile dyeing and finishing, biopharmaceuticals, natural product extraction, chemical reactions, and material processing. Among them, the method of forming microemulsions in supercritical fluid can overcome the limitations such as the inherent hydrophobicity of the fluid itself (e.g., the hydrophobicity of SCF-CO₂), thereby expanding its application scope. For example, by using SCF-CO₂ microemulsions, relevant polar target substances can be easily carried into the hydrophobic fluid medium through the hydrophilic environment in the core of the microemulsion, realizing application processing for different purposes. Existing literatures have reported the use of SCF-CO₂ microemulsions to achieve pre-treatment processes for textiles such as desizing, degumming, scouring, and bleaching, as well as color-fixing reactions of related dyes on fibers. However, there are no literature reports on the use of this technology to generate structural colors and related patterns so far.

### SUMMARY OF THE INVENTION

The present invention aims to provide a structural color system based on supercritical microemulsion phase separation, a preparation method and an application thereof, which is a new type of coloration material with both flexibility and environmental protection properties.

The technical solution to achieve the objective of the present invention is to provide a method for preparing a structural color system based on supercritical microemulsion phase separation, which comprises the following steps:

(1) preparing a working solution using an amphiphilic emulsifier, water, and a cosolvent as raw materials, placing the working solution in a working solution unit of a supercritical fluid system, turning on a circulating pump in the supercritical fluid system to perform forced circulation of the fluid, so that the working solution is mixed with a supercritical fluid medium, and forming a microemulsion in situ in a microemulsion unit;

(2) controlling the temperature and pressure of the supercritical fluid system to cause phase separation of the microemulsion, thereby obtaining a structural color system.

The working solution according to the present invention includes sodium bis-(2-ethylhexyl) sulfosuccinate, water, ethanol, and polymeric mixed protease. The polymeric mixed protease includes one of cellulase, α-amylase, pectinase, and lipase, or any combination thereof.

In Step (1), the ratio of dynamic to static circulation time for the forced circulation of the fluid is 1:1˜1:10. In Step (2), the temperature of the supercritical fluid system is controlled within the range of 0˜200° C., and the pressure is controlled within the range of 0˜7 MPa.

In the method for preparing a structural color system based on supercritical microemulsion phase separation according to the present invention, when the pressure of the supercritical fluid system is adjusted to vary within the range of 4 MPa˜0 MPa and the corresponding temperature conditions are controlled, the obtained structural color system presents a pattern shape. The pattern shapes include spherical, spheroid-like, or three-dimensional polygon-like shapes. Moreover, the structural color system includes deep black neutral colors or various types of colors.

The technical solution of the present invention also includes a structural color system based on supercritical microemulsion phase separation obtained by the above preparation method.

The structural color system based on supercritical microemulsion phase separation according to the present invention can be used as a coloration material, or for the preparation of color-developing or light-shielding devices, or in the field of flexible wearables.

The present invention uses supercritical fluid (especially SCF-CO₂ fluid) to first form a specific type of microemulsion therein, and then changes the system conditions to cause a certain degree of phase separation of the system. Under specific conditions, the system will produce relevant structural coloration phenomena, and at the same time, patterns of different shapes can be obtained by controlling different conditions.

### Advantageous Effects

1. By using the method of the present invention, a structural color system can be effectively generated based on supercritical microemulsion phase separation, providing a new technical solution and basic support for the preparation of new color-developing or light-shielding devices and the research and development of other related coloration materials.

2. The structural color system prepared by the method of the present invention can present relevant color tones such as deep black, and can also generate patterns of different shapes under controlled appropriate conditions. In addition, through methods such as pressurizing and depressurizing the system, the alternating cycle of the two processes of coloration and pattern formation can be realized.

3. The greatest advantage of the structural color system generated by the method of the present invention is its flexible characteristics. If the external packaging conditions meet the requirements of flexibility, transparency, etc., it can be applied in fields such as flexible wearables, and is easy to realize reuse.

4. The method of the present invention does not involve the use of chemicals such as colorants, so there are no environmental problems such as high emissions and high pollution. In addition, the process flow is simple, the operation is convenient, and it has the characteristics of greenness, ecology, environmental protection, energy conservation, and emission reduction.

### BRIEF DESCRIPTION OF THE DRAWINGS

FIG. 1 is a schematic diagram of the system for supercritical fluid microemulsion formation, phase separation, and structural color generation provided by the present invention.

Wherein: (1) is a medium (e.g., CO₂) gas cylinder; (2, 6, 9, 11, 13, 14) are valves; (3) is a condenser; (4) is a pressure pump; (5) is a preheater; (7) is an additive (working solution) unit; (8) is a filter; (10) is a microemulsion unit; (12) is a circulating pump; (15) is a fine adjustment valve; (16, 19) are thermometers; (17, 20) are pressure gauges; (18) is a separation unit; (21) is a purification unit; (22) is an online detection and viewing window unit.

FIG. 2 is a diagram showing the formation process of the SCF-CO₂ microemulsion system, phase separation, structural color system formation, and pattern formation in Example 1 of the present invention.

FIG. 3 is a diagram showing the formation process of the SCF-CO₂ microemulsion system, phase separation, structural color system formation, and pattern formation in Example 2 of the present invention.

FIG. 4 is a diagram showing the formation process of the SCF-CO₂ microemulsion system, phase separation, structural color system formation, and pattern formation in Example 3 of the present invention.

FIG. 5 is a diagram showing the formation process of the SCF-CO₂ microemulsion system, phase separation, structural color system formation, and pattern formation in Example 4 of the present invention.

### DETAILED DESCRIPTION OF THE INVENTION

The technical solution of the present invention will be further described below in conjunction with the drawings and examples.

### Example 1

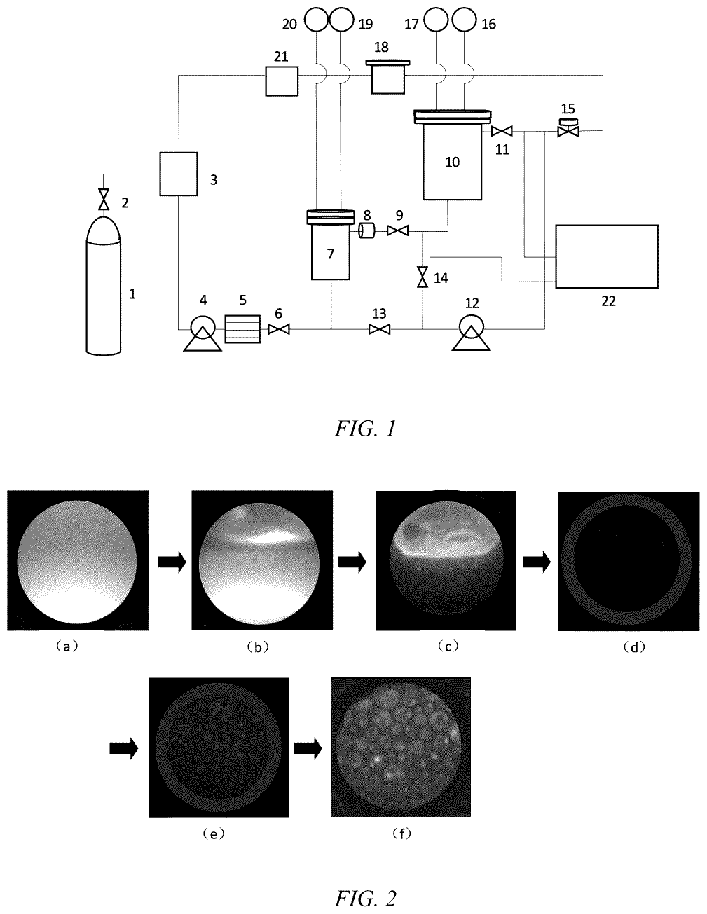

This example provides a method for preparing a structural color system, and the equipment system used is as shown in FIG. 1.

With reference to FIG. 1, the steps for forming a microemulsion, generating structural colors, and producing patterns in fluids such as SCF-CO₂ in this example are as follows:

Place the working solution composed of various components required for forming the microemulsion (such as emulsifier, an appropriate amount of water, cosolvent, and polar target substance) in the additive unit 7, and then close and seal the top cover of the unit. Close the fine adjustment valve 15 and the stop valve 14 in the system, open the stop valves 2, 6, 9, and 11 in sequence, feed a predetermined amount of the fluid medium (e.g., CO₂) into the additive (working solution) unit 7 and the microemulsion unit 10, and heat the additive unit 7 and the microemulsion unit 10 to the preset target temperature. At the same time, start the circulating pump 12 to perform circulation treatment on the series loop of the additive unit 7 and the microemulsion unit 10, so that various auxiliaries in the additive unit 7 fully interact with the medium to form a uniform and stable microemulsion system in situ. At the same time, observation and recording are carried out through the online detection and viewing window unit 22 configured in the system. Then, close the circulating pump 12 and the stop valve 9, and slowly open the fine adjustment valve 15 to adjust the microemulsion unit 10, and gradually carry out phase separation under different conditions, thereby generating corresponding structural colors and patterns, which are observed and recorded throughout the process through the online detection and viewing window unit 22.

According to requirements, the stop valve 9 and/or the pressure pump 4 can also be opened to supplement pressure to the microemulsion unit 10, and the fine adjustment valve 15 is used in conjunction to realize the alternating cycle of the two processes of structural coloration and pattern formation.

After the formation of the structural color system and patterns is completed, open the fine adjustment valve 15 to release the pressure of the system, and use the separation and recovery system composed of the separation unit 18, purification unit 21, condenser 3, medium gas cylinder 1, etc. to separate and recover the working solution and the medium gas.

In this example, 0.5 g of sodium bis-(2-ethylhexyl) sulfosuccinate (AOT), 40 mL of water, 10 mL of ethanol, and 0.4 g of polymeric mixed protease (0.1 g each of cellulase, α-amylase, pectinase, and lipase) are prepared into a working solution, which is placed in the additive unit 7, and the top cover thereof is sealed. Experiments are carried out in accordance with the specific implementation method and operation provided in this example. Under the process conditions of a fluid pressure of 15 MPa, a temperature of 60° C., and a fluid circulation-to-static ratio of 1:10, treatment is performed for 60 minutes to form the SCF-CO₂ microemulsion. Then, the fine adjustment valve 15 is slowly opened for phase separation, and the online observation and recording device is turned on at the same time. The experimental results are shown in FIG. 2.

With reference to FIG. 2, FIGS. a-f are the experimental results of in-situ generation of the SCF-CO₂ microemulsion in the equipment system shown in FIG. 1 using the method described in this example, followed by phase separation and gradual generation of the structural color system and patterns. Among them: FIG. (a) shows the SCF-CO₂ microemulsion formed after treatment at 15 MPa and 60° C. for 60 minutes; FIG. (b) shows the state where the SCF-CO₂ microemulsion undergoes obvious phase separation after treatment at 4-5 MPa and 58.9° C.; FIG. (c) shows the state where black structural colors are generated in the system at 1-2 MPa and 57.4° C.; FIG. (d) shows the state where a deep black structural color system is formed in the system at 0-1 MPa and 54.6° C.; FIG. (c) shows the state where some dark fine patterns are formed in the system at 0-0.5 MPa and 53.3° C.; FIG. (f) shows the state where some spherical or spheroid-like patterns are formed in the system at 0-0.5 MPa and 52.4° C.

In FIG. 2, FIG. (a) shows that under the conditions of this example, the added working solution can form the SCF-CO₂ microemulsion in the SCF-CO₂ system after treatment at 15 MPa and 60° C. for 60 minutes; the microemulsion is stable in state and uniformly distributed in the SCF-CO₂ system, presenting a translucent state, and part of the bottom of the viewing window shows a white light phenomenon. This indicates that the incident white light from the light source set opposite the observation window can partially or mostly pass through the SCF-CO₂ microemulsion system in the observation window; and the SCF-CO₂ microemulsion at the interface of the observation window can also partially or mostly reflect the incident visible light. FIG. (b) shows that when the system pressure is adjusted below the critical point of 7.38 MPa (e.g., 4-5 MPa), the SCF-CO₂ microemulsion system in FIG. (b) exhibits an obvious phase separation phenomenon, with part of the CO₂ gas phase appearing at the top of the viewing window, but most areas such as the middle and lower parts of the viewing window are still in the translucent SCF-CO₂ microemulsion state. When the system conditions are further adjusted, as shown in FIG. 2(c), the translucent SCF-CO₂ microemulsion state in the system disappears, the lower half of the viewing window becomes opaque, and a large number of black structural colors appear. At the same time, with the continuous evolution of the system, the entire viewing window or system becomes increasingly blurred and darker, and the black structural colors gradually fill the entire volume of the viewing window or the system, with the color tone deepening continuously, and finally a deep black structural color system as shown in FIG. (d) is formed. In addition, when the system conditions are further adjusted, the structural colors generated in the system will further evolve, the system interface in the viewing window will produce weak reflection of incident visible light, and a large number of small spherical patterns appear, as shown in FIG. (c); and with further adjustment of the system conditions, the system will continue to evolve, the interface of the viewing window or the system gradually becomes brighter and can reflect part of the incident light, and the formed spherical patterns are clearly visible with increased sizes, as shown in FIG. (f). The above results indicate that under the conditions of this example, based on the in-situ formed SCF-CO₂ microemulsion system, by adjusting the system conditions, the system can undergo phase separation and effectively generate structural colors, and can further form related patterns.

### Example 2

In this example, in-situ generation of the SCF-CO₂ microemulsion is carried out in the equipment system shown in FIG. 1, followed by experiments of phase separation and gradual generation of structural colors and patterns. Except for the different system conditions recorded online during the phase separation of the SCF-CO₂ microemulsion system and the formation of structural colors and patterns, other experimental conditions and specific operations are the same as those in Example 1, and specific reference can be made to the implementation method of Example 1.

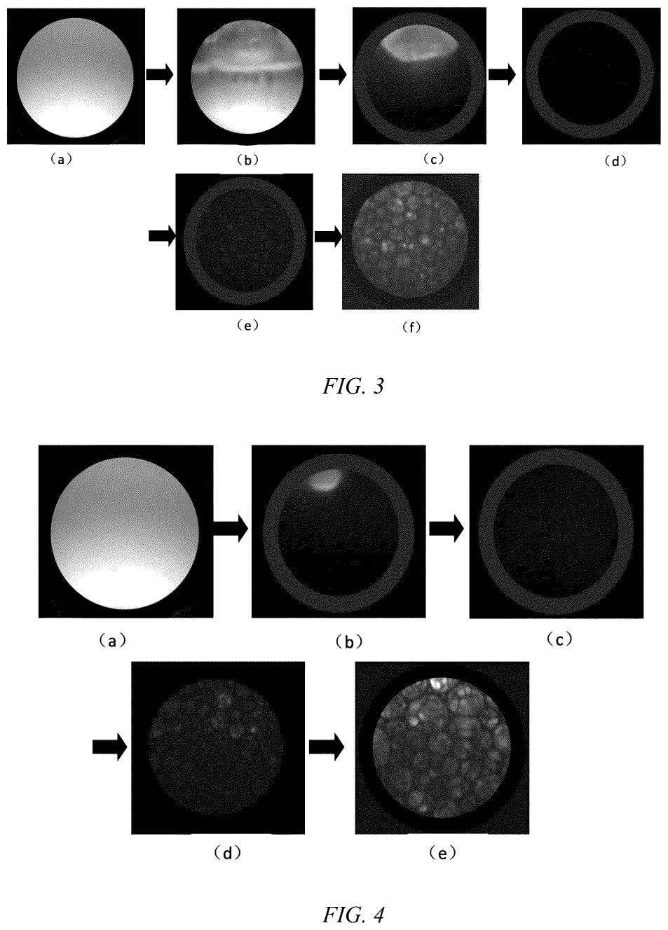

With reference to FIG. 3, FIGS. a-f are the experimental results obtained by changing the system conditions using the method described in this example. Among them: FIG. (a) shows the SCF-CO₂ microemulsion formed after treatment at 15 MPa and 60° C. for 60 minutes; FIG. (b) shows the state where the SCF-CO₂ microemulsion undergoes obvious phase separation at 3-4 MPa and 58.4° C.; FIG. (c) shows the state where black structural colors are generated in the system at 1-1.5 MPa and 57.4° C.; FIG. (d) shows the state where a deep black structural color system is formed in the system at 0-0.5 MPa and 41.8° C.; FIG. (e) shows the state where some dark fine patterns are formed in the system at 0-0.3 MPa and 41.4° C.; FIG. (f) shows the state where some spherical or spheroid-like patterns are formed in the system at 0-0.2 MPa and 40.1° C.

Compared with Example 1, FIGS. 3(a) and 3(b) show that under the conditions of this example, the same SCF-CO₂ microemulsion system formed continues to undergo phase separation when the system pressure is adjusted to a relatively lower value (e.g., 3-4 MPa in FIG. 3(b)), with a higher proportion of gas phase and a continuous decrease in the proportion of the microemulsion phase. When the system pressure and temperature are adjusted to 1-1.5 MPa and 57.4° C., as shown in FIG. 3(c), black structural colors also appear, and the proportion is higher than that in FIG. 2(c). At the same time, when the system temperature and pressure conditions are adjusted to 0-0.5 MPa and 41.8° C., the system presents a deep black structural color, as shown in FIG. 3(d). In addition, when the system conditions are controlled at 0-0.3 MPa and 41.4° C., and 0-0.2 MPa and 40.1° C., weak reflection of incident light begins to appear at the interface of the viewing window, and patterns of different sizes are gradually formed and presented in the system. With the change of system conditions, the patterns become increasingly clear and bright, and their sizes continuously increase, as shown in FIGS. 3(c) and 3(f). The above results indicate that in the SCF-CO₂ microemulsion system, when different phase separation conditions are changed, the phase separation, structural color formation, and pattern generation are reproducible. Moreover, the degree of phase separation, the proportion of structural color generation, and the formation and appearance of patterns are related to the specific conditions of the system, and have a wide adjustable range.

### Example 3

In this example, in-situ generation of the SCF-CO₂ microemulsion is carried out in the equipment system shown in FIG. 1, followed by experiments of phase separation and gradual generation of structural colors and patterns.

The method adopted in this example is as follows: 0.6 g of sodium bis-(2-ethylhexyl) sulfosuccinate (AOT), 40 mL of water, 10 mL of ethanol, and 0.4 g of polymeric mixed protease (0.1 g each of cellulase, α-amylase, pectinase, and lipase) are prepared into a working solution, which is then placed in the additive unit 7 and the top cover thereof is sealed. Then, experiments are carried out in accordance with the specific implementation method and operation described above. Under the conditions of a fluid pressure of 13 MPa, a temperature of 50° C., and a fluid circulation-to-static ratio of 1:10, treatment is performed for 40 minutes to form the SCF-CO₂ microemulsion. Then, the fine adjustment valve 15 is slowly opened for phase separation, and online observation and recording are carried out at the same time.

The obtained experimental results are shown in FIG. 4. Among them: FIG. (a) shows the SCF-CO₂ microemulsion formed after treatment at 13 MPa and 50° C. for 40 minutes; FIG. (b) shows the state where a large number of black structural colors are generated by phase separation at 2-3 MPa and 46.5° C.; FIG. (c) shows the state where a deep black structural color system is formed in the system at 0-0.3 MPa and 41.8° C.; FIG. (d) shows the state where some dark fine patterns are formed in the system at 0-0.2 MPa and 40.5° C.; FIG. (e) shows the state where some spherical or spheroid-like patterns are formed in the system at 0-0.1 MPa and 40.0° C.

FIG. 4(a) shows that, compared with Examples 1-2, under the conditions of this example, by changing the composition of the working solution and the system formation conditions, a good, almost identical, and stable SCF-CO₂ microemulsion system can also be obtained. FIG. 4(b) shows that by accelerating the adjustment of the system pressure and temperature conditions, black structural colors can be formed quickly, and the process and time for structural color formation can be shortened. A large number of deep black structural colors can also be formed at 0-0.3 MPa and 41.8° C., as shown in FIG. 4(c). Similar to the cases in Examples 1-2, when the system conditions are further adjusted to 0-0.2 MPa and 40.5° C., and 0-0.1 MPa and 40.0° C., weak reflection of incident light appears at the system interface, and the dark patterns formed in the system are gradually visible. With further changes in the system conditions, the patterns become increasingly clear and bright, and the patterns show a continuous growth trend, as shown in FIGS. 4(d) and 4(c). The above indicates that in the SCF-CO₂ system, by appropriately reducing the system pressure and temperature and shortening the formation time, a stable SCF-CO₂ microemulsion system can also be effectively formed; at the same time, by quickly adjusting the system phase separation conditions, deep black structural colors can also be formed quickly, and patterns can be further formed.

### Example 4

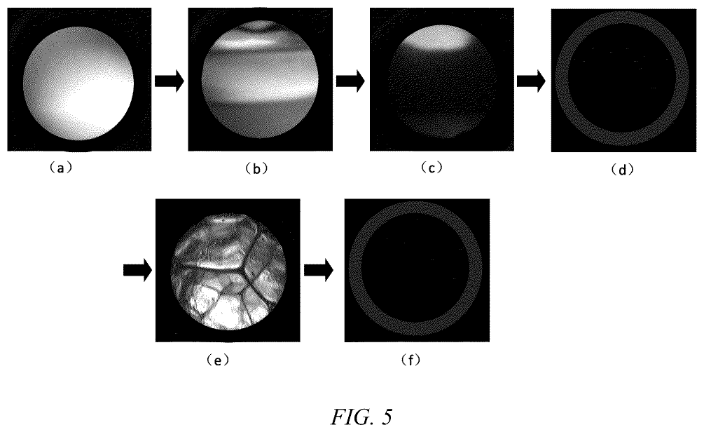

With reference to FIG. 5, FIGS. a-f are the experimental results of in-situ generation of the SCF-CO₂ microemulsion in the equipment system shown in FIG. 1 using the method described below in this example, followed by phase separation and gradual generation of structural colors and patterns. Except for the different system conditions recorded online during the phase separation of the SCF-CO₂ microemulsion system and the formation of structural colors and patterns, other experimental conditions and specific operations are the same as those in Example 3, and specific reference can be made to the implementation method. Among them: FIG. (a) shows the SCF-CO₂ microemulsion formed after treatment at 14 MPa and 50° C. for 40 minutes; FIG. (b) shows the state where the SCF-CO₂ microemulsion undergoes obvious phase separation at 5.5-7 MPa and 31.6° C.; FIG. (c) shows the state where a deep black structural color system is formed in the system at 2-3 MPa and 25.0° C.; FIG. (d) shows the state where a deep black structural color system is formed in the system at 0-2 MPa and 22.5° C.; FIG. (c) shows the state where polygonal patterns are formed in the system at 0-0.3 MPa and 20.0° C.; FIG. (f) shows the state where a deep black structural color system is formed again in the system when the system conditions are readjusted and phase separation is performed to 2-3 MPa and 30.0° C.

Compared with the aforementioned Examples 1-3, FIGS. 5(a) and 5(b) show that under the conditions of this example, for the formed SCF-CO₂ microemulsion system, when the system pressure is adjusted to a relatively high value, even at a relatively low temperature (e.g., 5.5-7 MPa and 31.6° C. in FIG. 5(b)), the microemulsion system can also undergo an obvious multi-layer phase separation phenomenon. When the system pressure and temperature conditions are further adjusted to 2-3 MPa and 25.0° C., as shown in FIG. 5(c), a large number of deep black structural colors appear. At the same time, as shown in FIG. 5(d), when the system conditions are further adjusted to 0-2 MPa and 22.5° C., the system is completely filled with the deep black structural color. In addition, when the system conditions are continuously adjusted to 0-0.3 MPa and 20.0° C., polygonal patterns are formed and presented in the system, and with the change of system conditions, the sizes of the patterns also show a continuous growth trend, as shown in FIG. 5(e). If the system conditions are readjusted and phase separation is performed, a deep black structural color system is formed again in the system, as shown in FIG. 5(f). This example indicates that in the SCF-CO₂ microemulsion system, adjusting different phase separation conditions may result in different phase separation behaviors, but structural colors can still be effectively generated; however, the shapes of the generated patterns may also change; and by readjusting the system conditions, phenomena such as structural color generation can be recycled again.

1. A method for preparing a structural color system based on supercritical microemulsion phase separation, characterized by comprising the following steps:
(1) preparing a working solution using an amphiphilic emulsifier, water, and a cosolvent as raw materials, placing the working solution in a working solution unit of a supercritical fluid system, turning on a circulating pump in the supercritical fluid system to perform forced circulation of the fluid, so that the working solution is mixed with a supercritical fluid medium, and forming a microemulsion in situ in a microemulsion unit;
(2) controlling the temperature and pressure of the supercritical fluid system to cause phase separation of the microemulsion, thereby obtaining a structural color system.

2. The method for preparing a structural color system based on supercritical microemulsion phase separation according to claim 1, characterized in that the working solution comprises sodium bis-(2-ethylhexyl) sulfosuccinate, water, ethanol, and polymeric mixed protease.

3. The method for preparing a structural color system based on supercritical microemulsion phase separation according to claim 1, characterized in that the ratio of dynamic to static circulation time for the forced circulation of the fluid is 1:1˜1:10.

4. The method for preparing a structural color system based on supercritical microemulsion phase separation according to claim 1, characterized in that in step (2), the temperature of the supercritical fluid system is controlled within the range of 0˜200° C., and the pressure is controlled within the range of 0˜7 MPa.

5. The method for preparing a structural color system based on supercritical microemulsion phase separation according to claim 1, characterized in that the pressure of the supercritical fluid system is adjusted to vary within the range of 4 MPa˜0 MPa, and the temperature conditions are controlled, so that the structural color system presents a pattern shape.

6. The method for preparing a structural color system based on supercritical microemulsion phase separation according to claim 1, characterized in that the structural color system comprises deep black neutral colors or various types of colors.

7. The method for preparing a structural color system based on supercritical microemulsion phase separation according to claim 2, characterized in that the polymeric mixed protease comprises one of cellulase, α-amylase, pectinase, and lipase, or any combination thereof.

8. The method for preparing a structural color system based on supercritical microemulsion phase separation according to claim 5, characterized in that the pattern shapes include spherical, spheroid-like, or three-dimensional polygon-like shapes.

9. A structural color system based on supercritical microemulsion phase separation, obtained by the preparation method according to claim 1.

10. Use of the structural color system based on supercritical microemulsion phase separation according to claim 9, characterized in that the structural color system is used as a coloration material, for the preparation of color-developing or light-shielding devices, or in the field of flexible wearables.
